(19) United States
(12) Patent Application Publication
(10) Pub. No.: US 2011/0258362 A1
(43) Pub. Date: Oct. 20, 2011

(54) REDUNDANT DATA STORAGE FOR UNIFORM READ LATENCY

(76) Inventors: Moray McLaren, Bristol (GB); Jr. Eduardo Argollo de Oliveira Dias, Barcelona (ES); Paolo Faraboschi, Barcelona (ES)

(21) Appl. No.: 13/140,603

(22) PCT Filed: Dec. 19, 2008
(86) PCT No.: PCT/US2008/087632

§ 371 Date: Jun. 17, 2011

(51) Int. Cl. G06F 12/06

(52) U.S. Cl. 711/5; 711/E12.082

(57) ABSTRACT

A memory apparatus (100, 200, 300, 500, 600, 700) has a plurality of memory banks (d0 to d7, m0 to m3, p, p0, p1), wherein a write or erase operation to the memory banks (d0 to d7, m0 to m3, p, p0, p1) is substantially slower than a read operation to the banks (d0 to d7, m0 to m3, p, p0, p1). The memory apparatus (100, 200, 300, 500, 600, 700) is configured to read a redundant storage of data instead of a primary storage location in the memory banks (d0 to d7, m0 to m3, p, p0, p1) for the data or reconstruct requested data in response to a query for the data when the primary storage location is undergoing at least one of a write operation and an erase operation.

### BACKGROUND

Solid-state memory is a type of digital memory used by many computers and electronic devices for data storage. The packaging of solid-state circuits generally provides solid-state memory with a greater durability and lower power consumption than magnetic disk drives. These characteristics coupled with the continual strides being made in increasing the storage capacity of solid-state memory devices and the relatively inexpensive cost of solid-state memory have contributed to the use of solid-state memory for a wide range of applications. In some applications, for example, nonvolatile solid-state memory may be used to replace magnetic hard disks or in regions of a processor's memory space that retain their contents when the processor is unpowered.

In most types of nonvolatile solid-state memory, including flash memory, write operations require a substantially greater amount of time to complete than read operations. Furthermore, because of the unidirectional nature of write operations in flash memory, data is typically only erased from flash memory periodically in large blocks. This type of erasure operation requires even more time to complete than a write operation.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1A is a diagram of an illustrative memory apparatus having a uniform read latency, in accordance with one exemplary embodiment of the principles described herein.

FIG. 1B is a diagram of an illustrative timing of read and write operations being performed on the illustrative memory apparatus of FIG. 1A, in accordance with one exemplary embodiment of the principles described herein.

FIG. 2 is a diagram of an illustrative memory apparatus having a uniform read latency, in accordance with one exemplary embodiment of the principles described herein.

FIG. 3 is a diagram of an illustrative memory apparatus having a uniform read latency, in accordance with one exemplary embodiment of the principles described herein.

FIG. 4 is a diagram of an illustrative timing of read and write operations being performed on the illustrative memory apparatus of FIG. 3, in is accordance with one exemplary embodiment of the principles described herein.

FIG. 5 is a diagram of an illustrative memory apparatus having a uniform read latency, in accordance with one exemplary embodiment of the principles described herein.

FIG. 6 is a diagram of an illustrative memory apparatus having a uniform read latency, in accordance with one exemplary embodiment of the principles described herein.

FIG. 7 is a diagram of an illustrative memory apparatus having a uniform read latency, in accordance with one exemplary embodiment of the principles described herein.

FIG. 8 is a block diagram of an illustrative data storage system having a uniform read latency, in accordance with one exemplary embodiment of the principles described herein.

FIG. 9A is a flowchart diagram of an illustrative method of maintaining a uniform read latency in an array of memory banks, in accordance with one exemplary embodiment of the principles described herein.

FIG. 9B is a flowchart diagram of an illustrative method of reading data from a memory system, in accordance with one exemplary embodiment of the principles described herein.

Throughout the drawings, identical reference numbers designate similar, but not necessarily identical, elements.

### DETAILED DESCRIPTION

As described above, in some types of digital memory, including, but not limited to flash memory and other nonvolatile solid-state memory, the amount of time required to write data to the memory may be significantly longer than the amount of time required to read data from the memory. Moreover, erase operations may require longer amounts of time to complete than write operations or read operations.

For most of these types of memory, read operations cannot occur concurrently with write or erase operations on the same memory device, thereby requiring that a read operation be delayed until any write or erase operation currently performed on the device is complete. Therefore, the worst case read latency in such a memory device may be dominated by the time required by an erase operation on the device.

However, in some cases, it may be desirable to maintain uniformity in read latency of data stored in a memory device, regardless of whether the memory device is undergoing a write or erase operation. Furthermore, it may also be desirable to minimize the read latency in such a memory device.

In light of the above and other goals, the present specification discloses apparatus, systems and methods of digital storage having a substantially uniform read latency. Specifically, the present specification discloses apparatus, systems and methods utilizing a plurality of memory banks configured to redundantly store data that is otherwise inaccessible during a write or erase operation at its primary storage location. The data is read from the redundant storage in response to a query for the data when the primary storage location is undergoing a write or erase operation.

As used in the present specification and in the appended claims, the term “bank” refers to a physical, addressable memory module. By way of example, multiple banks may be incorporated into a single memory system or device and accessed in parallel.

As used in the present specification and in the appended claims, the term “read latency” refers to an amount of elapsed time between when an address is queried in a memory bank and when the data stored in that address is provided to the querying process.

As used in the present specification and in the appended claims, the term “memory system” refers broadly to any system of data storage and access wherein data may be written to and read from the system by one or more external processes. Memory systems include, but are not limited to, processor memory, solid-state disks, and the like.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems and illustrative methods.

### Illustrative Systems

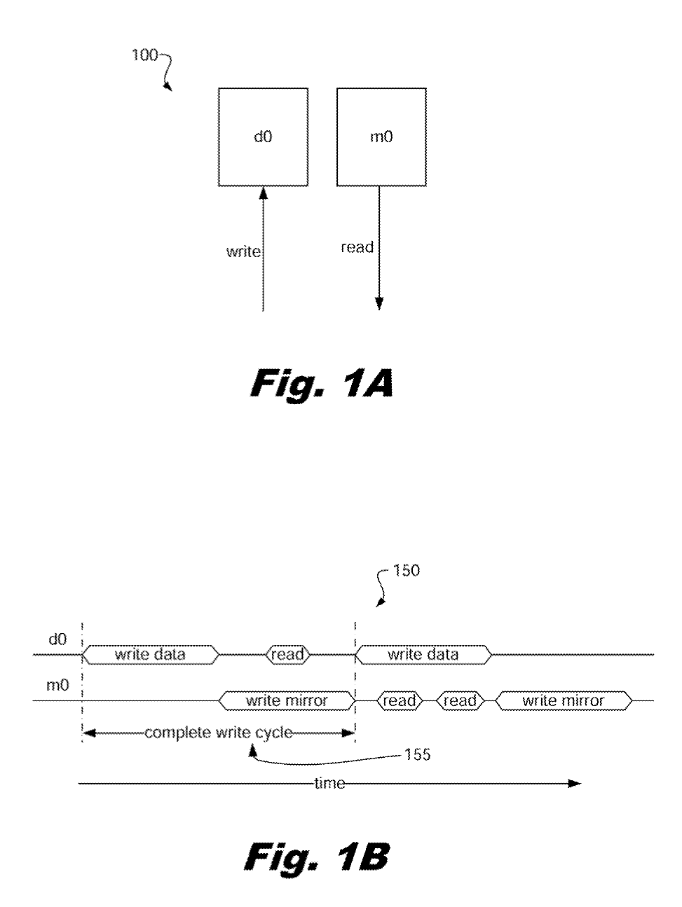

Referring now to FIG. 1A, an illustrative memory apparatus (100) is shown. For explanatory purposes, the systems and methods of the present specification will be principally described with respect to flash memory. However, it will be understood that the systems and methods of the present specification may and are intended to be utilized in any type of digital memory wherein at least one of a write operation or an erase operation requires a substantially greater amount of time to complete than a read operation. Examples of other types of digital memory to which the present systems and methods may apply include, but are not limited to, phase change memory (i.e. PRAM), UV-erase memory, electrically erasable programmable read only memory (EEPROM), and other programmable nonvolatile solid-state memory types.

The present example illustrates a simple application of the principles of the present specification. Flash memory banks (d0, m0) in a memory device may include a primary flash bank (d0) that serves as a primary storage location for data and a mirror bank (m0) that redundantly stores a copy of the data stored in the primary flash bank (d0). A write or erase operation would therefore require that each of the primary and the mirror banks (d0, m0) be updated to maintain consistent mirroring of data between the banks (d0, m0). A flash memory bank is typically inaccessible for external read queries while a write or erase operation is being performed. However, by staggering the write or erase operation such that the two flash memory banks (d0, m0) are never undergoing a write or erase operation concurrently, at least one of the primary data bank (d0) or the mirror data bank (m0) may be available to an external read query for the data stored in the banks (d0, m0). In the present example, new data is shown being written to the primary flash bank (d0) while the mirror flash bank (m0) services a read query. Conversely, while the mirror flash bank (m0) is undergoing a write or erase operation, the primary flash bank (d0) may service external read queries.

In certain embodiments, where both the primary flash bank (d0) and the mirror flash bank (m0) are available to service read queries, both flash banks (d0, m0) may service the queries. In alternative embodiments, only the primary flash bank (d0) may service read queries under such circumstances to preserve uniformity in read latency. Nonetheless, in every possible embodiment, the maximum read latency of the data stored in the primary and mirror flash banks (d0, m0) may be generally equivalent to that of the slower (if any) of the two flash banks (d0, m0).

Referring now to FIG. 1B, an illustrative timing (150) of read and write operations in the flash banks (d0, m0) is shown. Because data written to the primary flash bank (d0) must also be written to the mirror flash bank (m0) to preserve mirroring of the data, a complete write cycle (155) may include the staggered writing of duplicate data first to the primary flash bank (d0) and then to mirror flash bank (m0). Thus, a complete write cycle (155) to the memory apparatus (100) of FIG. 1A may require twice the amount of time to complete that a write cycle to a single flash bank (d0, m0) would require.

However, as shown in FIG. 1B, data stored in the banks (d0, m0) may be read continually throughout the write cycle (155). Which flash bank (d0, m0) provides the data to a querying read process may depend on which of the flash banks (d0, m0) is currently undergoing the write operation. The source of the data may be irrelevant to querying read process(es), though, as balancing the service of read queries between the flash banks (d0, m0) may be effectively invisible to the querying process(es). As will be described in more detail below, a read multiplexer may be used in a memory device incorporating redundant flash memory of this nature to direct data read queries to an appropriate source for data, depending on whether the flash banks (d0, m0) are undergoing an erase or write cycle (155) and the stage in the erase or write cycle (155) at which the read query is received.

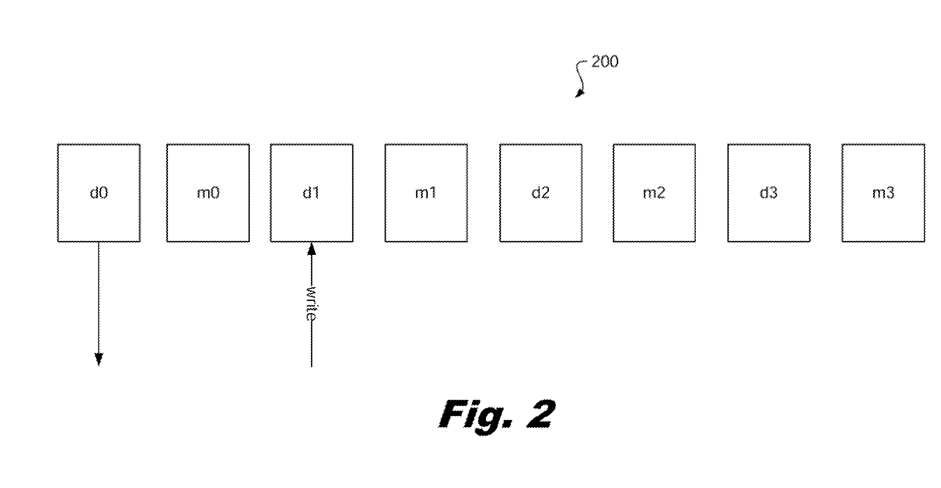

Referring now to FIG. 2, another illustrative embodiment of a memory apparatus (200) is shown. Much like the apparatus (100, FIG. 1A) described above, the present memory apparatus (200) employs data mirroring to provide redundancy in data storage to enable a uniform read latency to the flash memory device employing the memory banks (d0 to d3, m0 to m3).

In the present example, the mirroring principles described in FIGS. 1A-1B are extended from a single set of redundant flash banks to multiple redundant flash banks (d0 to d3, m0 to m3). A plurality of primary flash banks (d0 to d3) is present in the present example, and each of the primary flash banks (d0 to d3) is paired with a mirror flash bank (m0 to m3, respectively) configured to store the same data as its corresponding primary flash bank (d0 to d3). Similar to the memory apparatus (100, FIG. 1A) described previously, write operations to any primary flash bank (d2) is staggered with write operations to its corresponding mirror flash bank (m2) such that at least one flash bank (d0 to d3, m0 to m3) in each set of a primary flash bank (d0 to d3) and a corresponding mirror flash bank (m0 to m3) is available to a read process at any given time. Therefore, all of the data stored in the flash banks (d0 to d3, m0 to m3) may be available at any time to an external read query regardless of whether one or more write processes are being performed on the flash banks (d0 to d3, m0 to m3).

In certain embodiments, particularly those in which a plurality of flash banks (d0 to d3, m0 to m3) are configured to be read simultaneously to provide a single word of data, a write buffer may be incorporated with the flash banks (d0 to d3, m0 to m3). The write buffer may store data for write operations that are currently being written or yet to be written to the flash banks (d0 to d3, m0 to m3). In this way, the most current data can be provided to an external read process. A write buffer may be used with any of the exemplary embodiments described in the present specification, and the operations of such a write buffer will be described in more detail below.

The present example illustrates a set of four primary flash banks (d0 to d3) and four corresponding mirror flash banks (m0 to m3). It should be understood, however, that any suitable number of flash banks (d0 to d3, m0 to m3) may be used to create redundant data storage according to the principles described herein, as may best suit a particular application.

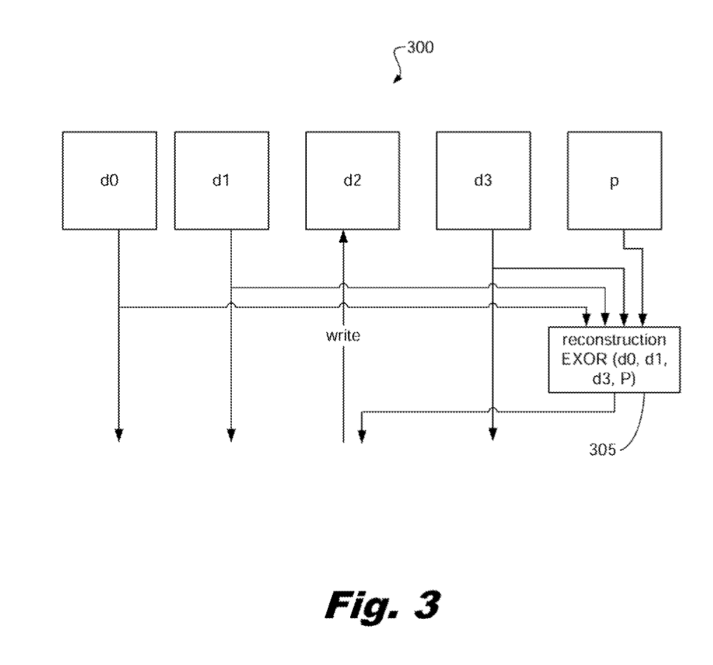

Referring now to FIG. 3, another illustrative memory apparatus (300) is shown. In the present example, four primary flash banks (d0 to d3) serve as the main storage of data. Like previous examples, data in the present example may be redundantly stored to provide a uniform read latency of the data, even in the event that one of the primary flash banks (d0 to d3) is being written or erased.

Unlike the previous examples, however, the present memory apparatus (300) does not provide redundancy of data by duplicating data stored in each primary flash bank (d0 to d3) in a corresponding mirror flash bank. Rather, the present example incorporates a parity flash bank (p) that may store parity data for the data stored in the primary flash banks (d0 to d3). The parity data stored in the parity flash bank (p) may be used in conjunction with data read at given addresses from any three of the primary flash banks (d0 to d3) to determine the data stored in the remaining of the primary flash banks (d0 to d3) without actually performing a read operation on the remaining primary flash bank (d0 to d3).

For example, as shown in FIG. 3, data striping may be used to distribute fragmented data across the primary flash banks (d0 to d3) such that read operations are performed simultaneously and in parallel to corresponding addresses of each of the primary flash banks (d0 to d3) to retrieve requested data. The requested data fragments are received in parallel from each of the primary flash banks (d0 to d3) and assembled to present the complete requested data to a querying process. However, if one (d2) of the primary flash banks (d0 to d3) is undergoing a write operation, that primary flash bank (d2) may be unavailable to perform read operations during the write operation. To maintain uniformity of the read latency of the fragmented data stored in the primary flash banks (d0 to d3), however, the requested data fragment stored primarily in primary flash bank (d2) may be reconstructed using the retrieved data fragments from the remaining primary flash banks (d0, d1, d3) and parity data from a corresponding address in the parity flash bank (p).

This reconstruction may be, for example, performed by a reconstruction module (305) having logical gates configured to perform an exclusive-OR (EXOR) bit operation on the data portions received from the accessible flash banks (d0, d1, d3) to generate the data fragment stored in the occupied primary flash bank (d2). The output of the reconstruction module (305) may then be substituted for the output of the occupied primary flash bank (d2), thereby providing the external read process with the complete data requested. This substitution may be performed by a read multiplexer (not shown), as will be described in more detail below.

In the present example, only one of the primary flash banks (d0 to d3) may undergo a write or erase operation at a time if complete data is to be provided to the external read process. Alternatively, a plurality of parity flash banks (p) may enable parallel write or erase processes among the primary flash banks (d0 to d3).

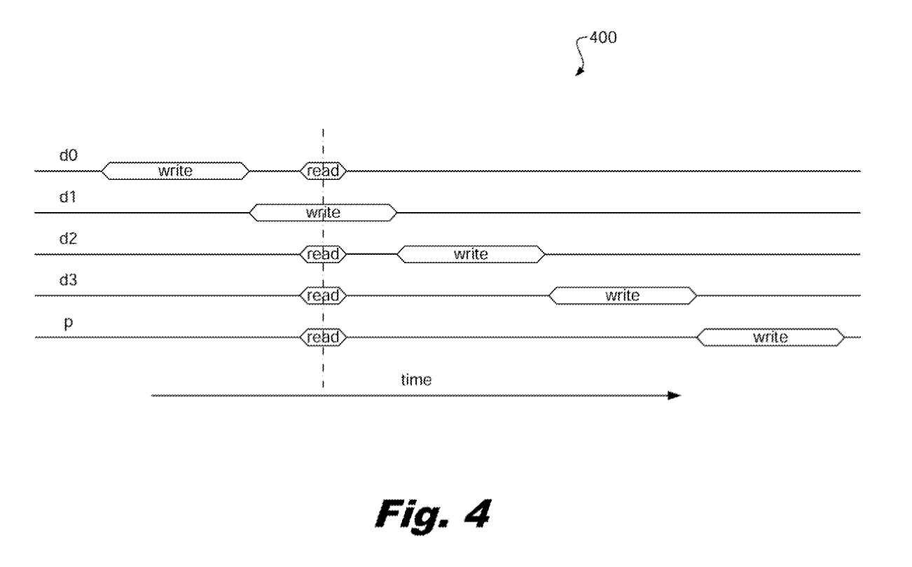

Referring now to FIG. 4, an illustrative timing (400) of read and write operations in the primary flash banks (d0 to d3) and the parity bank (p) of FIG. 3 is shown. Because data can only be written to or erased from one of the flash banks (d0 to d3, p) at a time in the present example, write operations to each of the primary and parity flash banks (d0 to d3, p) are staggered. Thus any of the data stored in the primary flash banks (d0 to d3) may be available to an external read process at any time, regardless of whether one of the flash is banks is undergoing a write or erase operation. This is because any striped data queried by an external read process may be recovered from any four of the five flash banks (d0 to d3, p) shown. As shown in FIG. 4, the fragmented data stored in the temporarily inaccessible primary flash bank (d1) may be reconstructed from corresponding data stored in the remaining, accessible primary flash banks (d0, d2, d3) and the accessible parity flash bank (p).

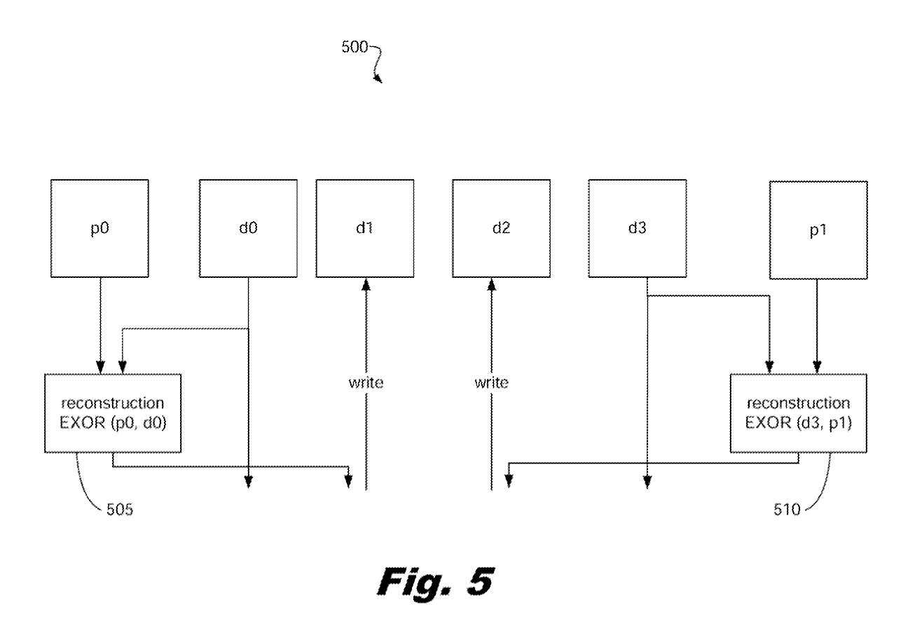

Referring now to FIG. 5, another illustrative memory apparatus (500) is shown. Similar to the example of FIGS. 3-4, the present example employs fragmented data striping distribution across a plurality of primary flash banks (d0 to d3). In contrast to the previous example's use of a single parity flash bank (p) in conjunction with primary flash banks (d0 to d3), the present example utilizes two parity flash banks (p0, p1) in conjunction with the primary flash banks (d0 to d3) to implement redundancy of data.

A first of the parity flash banks (p0) stores parity data corresponding to fragmented data in the first two primary flash banks (d0, d1), and a second parity flash bank (p1) stores parity data corresponding to striped data in the remaining two primary flash banks (d2, d3). First and second reconstruction modules (505, 510) are configured to reconstruct primary flash bank data from the first parity flash bank (p0) and the second parity flash bank (p1), respectively. By utilizing multiple parity flash banks (p0, p1), the write bandwidth of the flash memory banks (d0 to d3, p0, p1) may be increased, due to the fact that write or erase operations need only be staggered among a first group of flash banks (d0, d1 , p0) and a second group of flash banks (d2, d3, p1), respectively. This property allows for each of the groups to support a concurrent writing or erase process in one of its flash banks (d0 to d3, p0, p1) while still making all of the data stored in the primary flash banks (d0 to d3) available to an external read process.

In the present example, a primary flash bank (d1) in the first group is shown undergoing a write operation concurrent to a primary flash bank (d2) in the second group also undergoing a write operation. In response to an external read process, the reconstruction modules (505, 510) use parity data stored in the panty flash banks (p0, p1, respectively) together with data from the accessible primary flash banks (d0, d3, respectively) to recover the data stored in inaccessible flash banks (d1, d2) and provide that data to the external read process together with the data from the accessible flash banks (d1, d2).

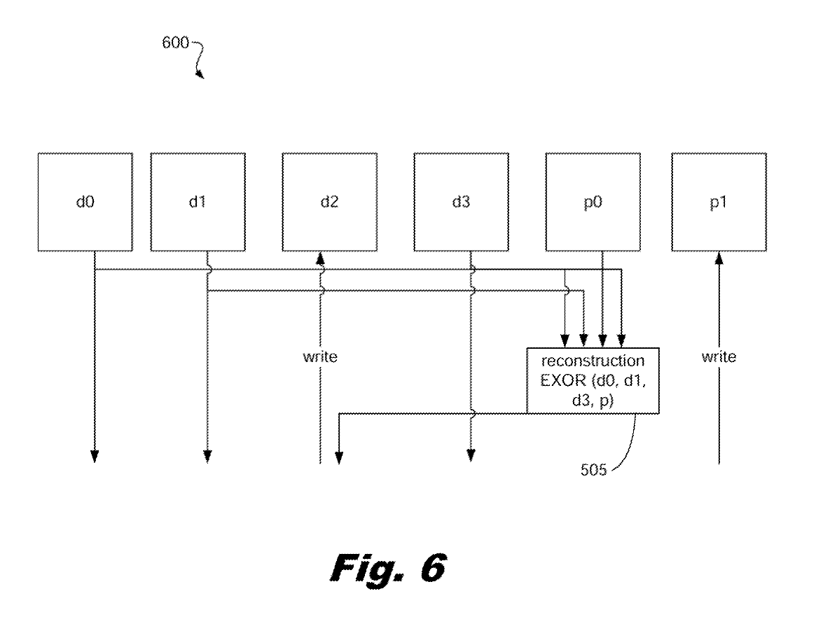

Referring now to FIG. 6, another illustrative memory apparatus (600) is shown. Similar to the example of FIGS. 5, the present example implements redundancy of data stored in the primary flash banks (d0 to d3) through data striping distribution across the primary flash banks (d0 to d3) together with two parity flash banks (p0, p1).

In contrast to the previous illustrative memory apparatus (500, FIG. 5), which uses two parity flash banks (p0, p1) in conjunction with two separate groups of primary flash banks (d0 to d3), the parity flash banks (p0, p1) of the present example store duplicate parity data for all of the primary flash banks (d0 to d3). In other words, the parity flash banks (p0, p1) use mirroring such that one of the parity flash banks (p0, p1) is always available to provide parity data to the reconstruction module (505).

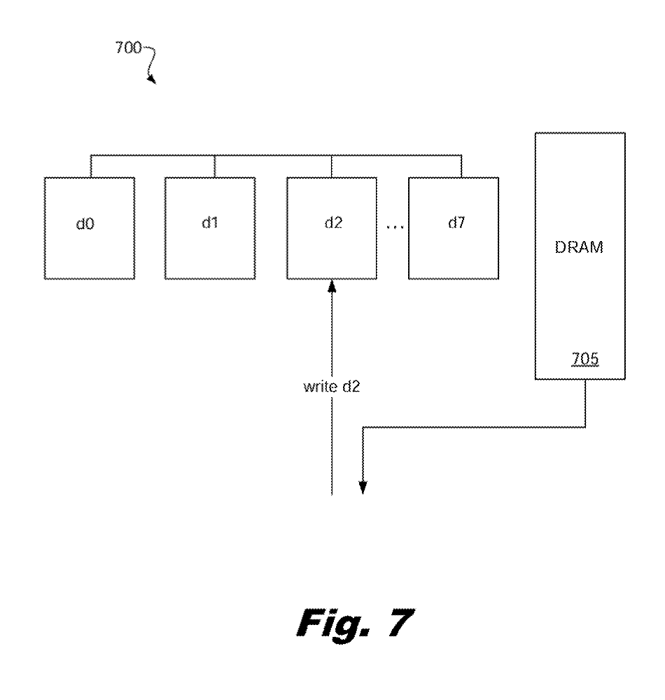

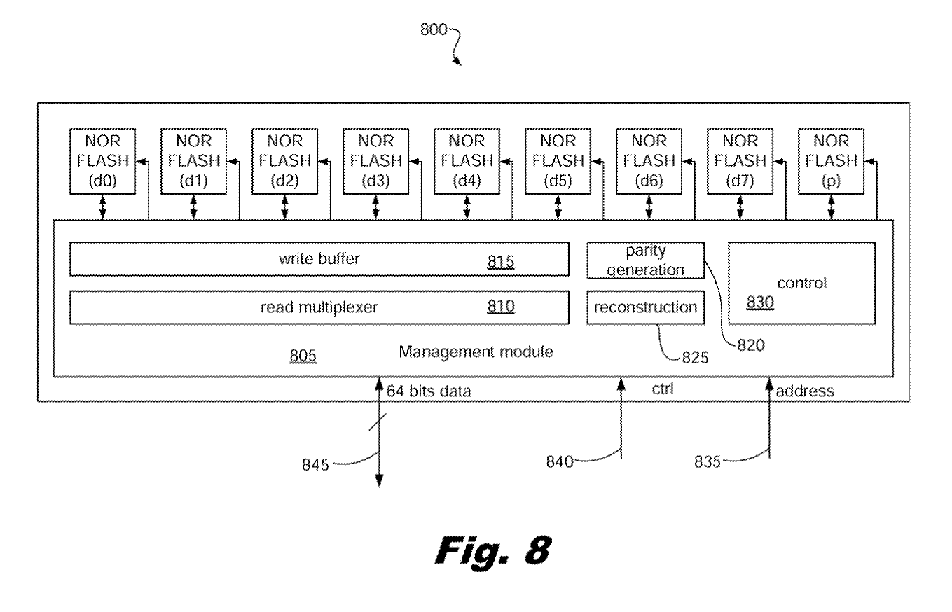

Referring now to FIG. 7, another illustrative memory apparatus (700) is shown. In the present example, a write buffer, which is embodied as a dynamic random-access memory (DRAM) module (705) is provided to implement redundancy of the data stored in primary flash memory banks (d0 to d7). The DRAM module (705) may be configured to mirror data stored in any or all of the primary flash memory banks (d0 to d7) such that the data stored by any flash memory bank (d0 to d7) that is inaccessible due to a write or erase operation may be provided by the DRAM module (705). In other embodiments, the primary flash memory banks (d0 to d7) may be configured to store striped data with the DRAM module (705) being configured to store panty data for the flash memory banks (d0 to d7) as described above with respect to previous embodiments. Additionally or alternatively, one or more write buffers (e.g. DRAM modules (705)) may serve to store data to be written in staggered write operations to the primary flash memory banks (d0 to d7).

Referring now to FIG. 8, a block diagram of an illustrative memory system (800) having a uniform read latency is shown. The illustrative memory system (800) may be implemented, for example, on a dual in-line is memory module (DIMM), for example, or according to any other protocol and packaging as may suit a particular application of the principles described herein.

The illustrative data storage system (800) includes a plurality of NOR flash memory banks (d0 to d7, p) arranged in a fragmented data-striping/parity redundancy configuration similar to that described previously in

FIG. 3. Alternatively, any other suitable configuration of flash memory banks (d0 to d7, p) may be used that is consistent with the principles of data redundancy for uniform read latency as described herein.

Each of the flash memory banks may be communicatively coupled to a management module (805) that includes a read multiplexer (810), a write buffer (815), a parity generation module (820), a reconstruction module (825), and control circuitry (830).

The system (800) may interact with external processes through input/output (i/o) pins that function as an address port (835), a control port (840), and a data port (845). In certain embodiments, the multi-bit address and data ports (835, 845) may be parallel data ports. Alternatively, the address and data ports (835, 845) may transport data serially. The control circuitry (830) may include a microcontroller or other type of processor or processing element that coordinates the functions and activities of the other components in the system (800).

An external process may write data to a certain address of the memory system (800) by providing that address at the address port (835), setting the control bit at the control port (840) to 1, and providing the data to be written at the data port (845). On a next clock cycle, control circuitry. (830) in the management module (805) may determine that the control bit at the control port (840) has been set to 1, store the address at the address port in a register of the control circuitry (830), and write the data to a temporary write buffer (815).

The temporary write buffer (815) may be useful in synchronous operations since the flash banks (d0 to d7, p) may require staggered writing to maintain a uniform read latency. The write buffer (815) may include DRAM or another type of synchronous memory to allow the data to be received synchronously from the external process and comply with DIMM protocol.

The control circuitry (830) may then write the data stored in the temporary write buffer (815) to the flash banks (d0 to d7, p), according to the staggered write requirement, by parsing the data in the write buffer (815) into fragments and allocating each fragment to one of the flash banks (d0 to d7) according to the address of the data and the fragmentation specifics of a particular application. The parity generation module (820) may update the parity flash bank (p) with new parity data corresponding to the newly written data in the primary flash banks (d0 to d7).

Similarly, an external process may read data by providing the address of the data being queried at the address port (835) to the management module (805) with the control bit at the control port (840) set to 0. The control circuitry (830) in the management module (805) may receive the address and determine from the control bit that a read is being requested from the external process. The control circuitry (830) may then query the portions of the flash memory banks (d0 to d7) that store the fragments of the data being at the address requested by the external process. If the control circuitry (830) determines that the address requested by the external process is currently being written or scheduled to be written, the control circuitry (830) may query the write buffer (815) and provide the requested data to the external process directly from the write buffer (815). However, if the data is not in the write buffer (815), but a staggered write or erase process is occurring to write data to the flash memory banks (d0 to d7, p) nonetheless, control circuitry (830) may use the reconstruction module (825) to reconstruct the requested data using data from the accessible primary flash banks (d0 to d7) and the parity flash bank (p). The control circuitry (830) may also provide a control signal to the read multiplexer (810) such that the read multiplexer (810) substitutes the output of the inaccessible flash bank (d0 to d7) with that of the reconstruction module (825). The read multiplexer (810) may be consistent with multiplexing principles known in the art, and employ a plurality of logical gates to perform this task.

### Illustrative Methods

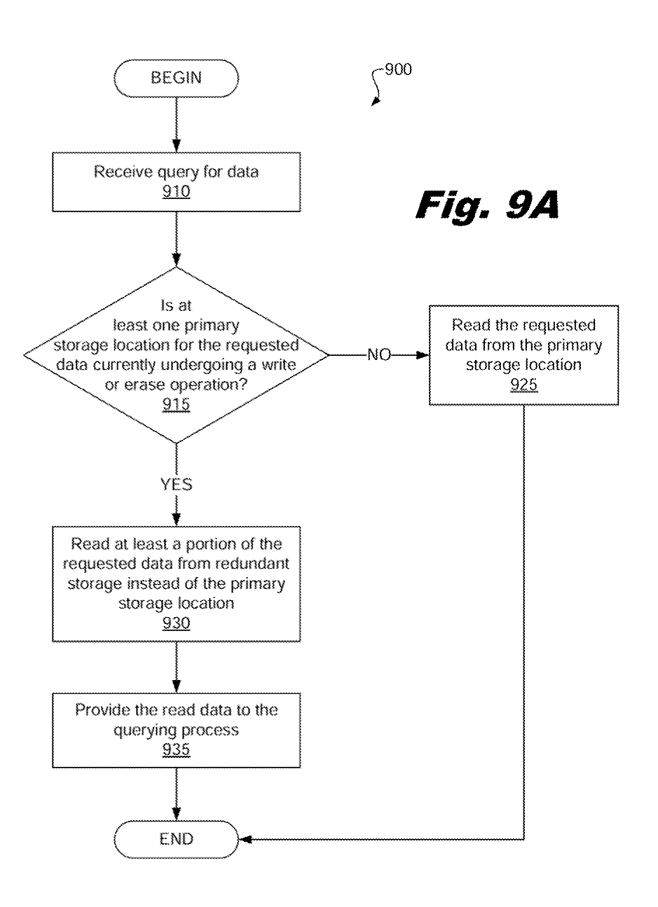

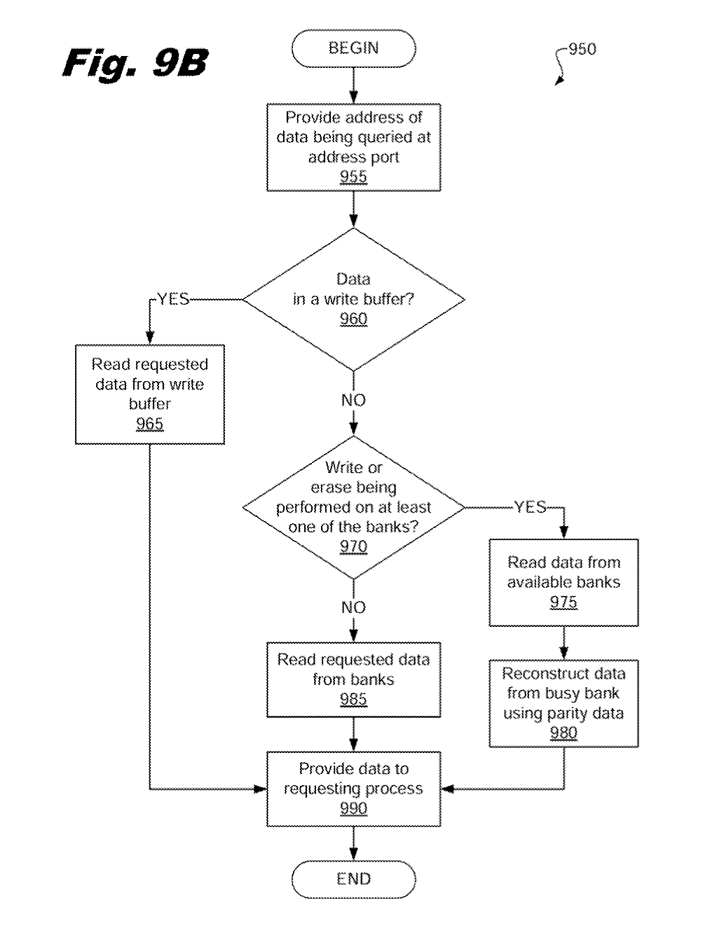

Referring now to FIG. 9A, a flowchart diagram of an illustrative method (900) of maintaining a uniform read latency in an array of memory banks is shown. The method (900) may be performed, for example, in a memory system (800, FIG. 8) like that described with reference to FIG. 8 above under the control of the management module (805), where at least one primary storage location for data requires more time to perform a write or erase operation than a read operation.

The method includes receiving (step 910) a query for data. The query for data may be received from an external process. An evaluation may then be made (decision 915) of whether at least one primary storage location for the requested data is currently undergoing a write or erase operation. If so, at least a portion of the requested data is read (step 930) from redundant storage instead of the primary storage location. In the event that no primary storage location of the data in question is currently undergoing a write or an erase operation, the data is read (step 925) from the primary storage location. Finally, the data is provided (step 935) to the querying process.

Referring now to FIG. 9B, a flowchart diagram of an illustrative method (950) of reading data from a memory system is shown. This method (950) may also be performed, for example, in a memory system (800, FIG. 8) like that described in reference to FIG. 8 above under the control of the management module (805) to maintain a substantially uniform read latency in the memory system (800, FIG. 8).

The method (950) may include providing (955) an address of data being queried at an address port of the memory system. It may then be determined (decision 960) whether the requested data corresponding to the supplied address is currently being stored in a write buffer (e.g., the requested data is in the process of being written to its corresponding memory banks in the memory system at the time of the read). If so, the requested data may be simply read (step 965) from the write buffer and provided (step 990) to the requesting process.

If the data corresponding to the address provided by the external process is not determined (decision 960) to be in a write buffer, a determination may be made (decision 970) whether a write or erase process is being performed on at least one of the memory banks storing the requested data. Where a write or erase process is not being performed on at least one of the memory banks storing the requested data, all of the memory banks storing the requested data may be available, for the data to be read (step 985) directly from the primary storage location of the memory and provided (step 990) to the requesting process.

In the event that a write or erase process is being performed on at least one of the banks storing the requested data, fragments of the data may be read (975) from any available memory banks and the remaining data fragment(s) may be reconstructed (step 980) using parity data stored elsewhere. After reconstruction, the data may then be provided (step 990) to the requesting process under a read latency substantially similar to that of providing the requested data after reading the requested data directly from the primary memory banks.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A memory apparatus (100, 200, 300, 500, 600, 700), comprising:
a plurality of memory banks (d0 to d7, m0 to m3, p, p0, p1), wherein a write or erase operation to said memory banks (d0 to d7, m0 to m3, p, p0, p1) is substantially slower than a read operation to said banks (d0 to d7, m0 to m3, p, p0, p1); and
wherein said memory apparatus (100, 200, 300, 500, 600, 700) is configured to read a redundant storage of data instead of a primary storage location in said banks (d0 to d7, m0 to m3, p, p0, p1) for said data in response to a query for said data when said primary storage location is undergoing at least one of a write operation and an erase operation, said memory apparatus (100, 200, 300, 500, 600, 700) comprising a substantially uniform read latency for data stored in said plurality of memory banks (d0 to d7, m0 to m3, p, p0, p1).

2. The memory apparatus (100, 200, 300, 500, 600, 700) of claim 1, wherein said memory banks (d0 to d7, m0 to m3, p, p0, p1) comprise flash memory.

3. The memory apparatus (100, 200, 300, 500, 600, 700) of claim 1, wherein said substantially uniform read latency is substantially smaller than at least one of a write latency and an erase latency of said primary storage location in said memory banks (d0 to d7, m0 to m3, p, p0, p1).

4. The memory apparatus (100, 200, 300, 500, 600, 700) of claim 1, further comprising a read multiplexer (810) configured to substitute said data from said redundant storage of data for said data from said primary storage location in the event that said primary storage location is undergoing said write operation or said erase operation.

5. The memory apparatus (100, 200, 300, 500, 600, 700) of claim 1, wherein said redundant storage of data comprises a memory bank (m0 to m3) separate from said primary storage location, wherein said redundant memory bank (p, p0, 01 is configured to mirror data stored said primary storage location.

6. The memory apparatus (100, 200, 300, 500, 600, 700) of claim 1, wherein said requested data is distributed among a plurality of said memory banks (d0 to d7, m0 to m3, p, p0, p1).

7. The memory apparatus (100, 200, 300, 500, 600, 700) of claim 6, wherein said redundant storage of data comprises parity data from which said requested data is derived using portions of said data distributed among said plurality of said memory banks (d0 to d7, m0 to m3, p, p0, p1).

8. A method (900) of maintaining a substantially uniform read latency in an array of memory banks (d0 to d7, m0 to m3, p, p0, p1), comprising:
responsive to a query for data, determining (915) whether a primary storage location for said data in said memory banks (d0 to d7, m0 to m3, p, p0, p1) is currently undergoing at least one of a write operation and an erase operation; and
if said primary storage location for said data is currently undergoing at least one of a write operation and an erase operation, reading said data from redundant storage instead of said primary storage location.

9. The method (900) of claim 8, wherein said data is distributed among individual memory banks (d0 to d7, m0 to m3, p, p0, p1) in said plurality of said memory banks, and said reading of said data from said redundant storage comprises reconstructing said data from distributed portions of said data and parity data.

10. The method (900) of claim 9, further comprising providing a control signal to a read multiplexer (810) such that said read multiplexer (810) substitutes said data from said redundant storage for data read from at least one of said memory banks (d0 to d7, m0 to m3, p, p0, p1).

11. The method (900) of claim 8, further comprising responsive to a determination that said data is stored in a temporary write buffer, reading said data directly from said temporary write buffer.

12. The method (900) of claim 8, wherein said query comprises an address provided at an address port of said

13. A data storage system (800) comprising:
a plurality of memory banks (d0 to d7, m0 to m3, p, p0, p1), wherein a write or erase operation to said memory banks (d0 to d7, m0 to m3, p, p0, p1) is substantially slower than a read operation to said memory banks; and
a read multiplexer (810) configured to read requested data from redundant storage in response to a determination that a primary storage location in said memory banks (d0 to d7, m0 to m3, p, p0, p1) for said requested data is undergoing at least one of a write operation and an erase operation.

14. The data storage system (800) of claim 13, further comprising a reconstruction module (305, 505, 510, 825) configured to reconstruct said data stored in said primary storage location from fragmented data distributed throughout said plurality of memory banks (d0 to d7, m0 to m3, p, p0, p1) and stored parity data.

15. The data storage system (800) of claim 13, further comprising a write buffer (815) configured to receive write data synchronously from an external process and store said write data while a staggered write process writes said write data to said plurality of memory banks (d0 to d7, m0 to m3, p, p0, p1).
